(19) United States
(12) Patent Application Publication
(10) Pub. No.: US 2014/0082018 A1
(43) Pub. Date: Mar. 20, 2014

(54) Device and Method for Obtaining Shared Object Related to Real Scene

(71) Applicants: Meng Xu, Beijing (CN); Ying Chen, Beijing (CN)

(72) Inventors: Meng Xu, Beijing (CN); Ying Chen, Beijing (CN)

(73) Assignee: BAIDU ONLINE NETWORK TECHNOLOGY (BEIJING) CO., LTD, Haidian District, Beijing (CN)

(21) Appl. No.: 14/006,511

(22) PCT Filed: Mar. 22, 2012
(86) PCT No.: PCT/CN12/72807

§ 371 Date: Dec. 2, 2013

(30) Foreign Application Priority Data
Mar. 22, 2011 (CN) 201110069874.9

(51) Int. Cl. G06F 17/30

(52) U.S. Cl. CPC G06F 17/30477
USPC 707/770

(57) ABSTRACT

An object of the present invention is to provide a method and device for obtaining a shared object associated with a real scene. A network device obtains an access respect sent by a user through user equipment based on the scene image corresponding to the real scene; performs match query in a shared object repository based on the scene image so as to obtain one or more shared objects corresponding to the access request; and provides said one or more shared objects to the user equipment. Compared with the prior art, through performing match query based on a scene image, the present invention provides a shared object associated with a real scene, which not only facilitates people to obtain information related to the scene, but also supports object sharing based on the same scene between different users, such that it is more convenient for people to obtain information and communicate with one another; besides, it also enhances use experience of users.

### FIELD OF THE INVENTION

The present invention relates to the field of Internet, and more specifically, to a technology of obtaining a shared object associated with a real scene.

### BACKGROUND OF THE INVENTION

The development and application of Internet technologies create and enrich people's approaches of obtaining information and mutual communication. For example, a user may share amusing anecdotes, events of interest, latest personal news, and other information with his/her friends via email, blog, or microblog, etc.

However, with the rapid development of the Internet communications technologies and terminal device technologies, in particular large-screen display and good human-machine interaction of user equipment, people gradually become unsatisfactory with the earliest text-preferred information obtaining or communication way and wish a more intuitive interaction for better user experience. For example, people wish to obtain relevant information about a scene. For example, when a user is located in a train station, he/she wishes that when his/her screen shows a scene of the train station, the screen of his/her user equipment would correspondingly display relevant information about the train station, which he/she wishes to learn, such as train schedule information, or other notices about the train station as shared by other users, and the like.

Therefore, it is one of imminent problems to be resolved by those skilled in the art how to enable a user to obtain a shared object associated with a real scene so as to enhance the user's communication efficiency and improve his/her use experience.

### SUMMARY OF THE INVENTION

An objective of the present invention is to provide a device and method for obtaining a shared object associated with a real scene.

According to one aspect of the present invention, there is provided a method for obtaining a shared object associated with a real scene at a network device, wherein the method comprises the following steps:

a. obtaining an access request sent by a user through user equipment and based on a scene image corresponding to a real scene;

b. performing match query in a shared object repository based on the scene image so as to obtain one or more shared objects corresponding to the access request;

c. providing said one or more shared objects to the user equipment.

According to another aspect of the present invention, there is provided a method for facilitating obtaining a shared object associated with a real scene at user equipment, wherein the method comprises the following steps:

A. obtaining a scene image corresponding to a real scene, the scene image being provided by a user through user equipment;

B. sending an access request based on the scene image to a network device;

wherein the method further comprises:
receiving one or more shared objects based on the access request, said one ore more shared objects being sent from the network device.

According to a further aspect of the present invention, there is further provided a network device for obtaining a shared object associated with a real scene, wherein the network device comprises:

first obtaining module configured to obtain an access request sent by a user through user equipment and based on a scene image corresponding to a real scene;

query module configured to perform match query in a shared object repository based on the scene image so as to obtain one or more shared objects corresponding to the access request;

providing module configured to provide said one or more shared objects to the user equipment.

According to a still further aspect of the present invention, there is further provided user equipment for facilitating obtaining a shared object associated with a real scene, wherein the user equipment comprises:

second obtaining module configured to obtain a scene image corresponding to a real scene, the scene image being provided by a user through user equipment;

sending module configured to send an access request based on the scene image to a network device;

wherein the user equipment further comprises:

receiving module configured to receive one or more shared objects based on the access request, said one ore more shared objects being sent from the network device.

According to a yet further aspect of the present invention, there is further provided a system for obtaining a shared object associated with a real scene, the system comprising the above network device and the above user equipment.

Compared with the prior art, through performing match query based on a scene image, the present invention provides a shared object associated with a real scene, which not only facilitates people to obtain information related to the scene, but also supports object sharing based on the same scene between different users, such that it is more convenient for people to obtain information and communicate with one another; besides, it also enhances use experience of users.

### BRIEF DESCRIPTION OF THE SEVERAL VIEWS OF THE DRAWINGS

Through reading the following detailed depiction on the non-limiting embodiments with reference to the accompanying drawings, the other features, objectives, and advantages of the present invention will become more apparent:

FIG. 1 shows a topological graph of a system for obtaining a shared object associated with a real scene according to one aspect of the present invention;

FIG. 2 shows a diagram of devices for obtaining a shared object associated with a real scene according to one aspect of the present invention;

FIG. 3 shows a diagram of devices for obtaining a shared object associated with a real scene according to one preferred embodiment of the present invention;

FIG. 4 shows a flow chart of a method for obtaining a shared object associated with a real scene according to another aspect of the present invention;

FIG. 5 shows a flow chart of a method for obtaining a shared object associated with a real scene according to one preferred embodiment of the present invention.

Same or like reference numerals in the accompanying drawings indicate the same or corresponding components.

### DETAILED DESCRIPTION OF THE INVENTION

Hereinafter, the present invention will be further described in detail with reference to the accompanying drawings.

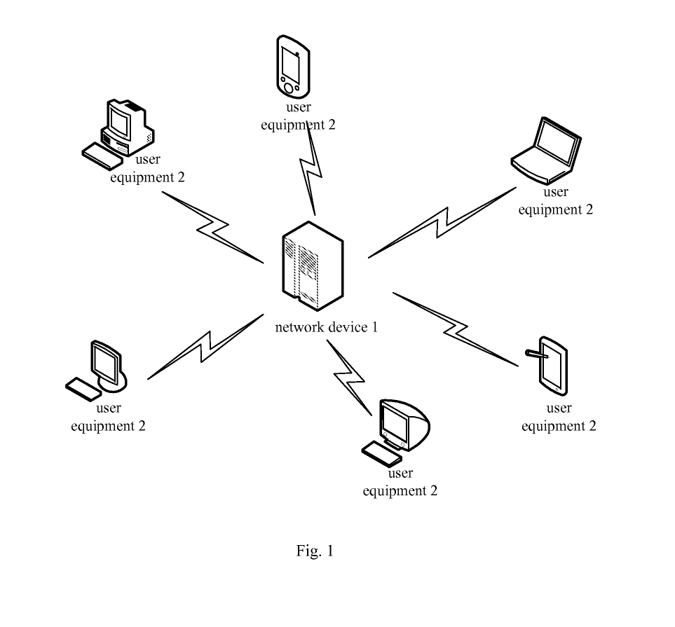

FIG. 1 shows a topological graph of a system for obtaining a shared object associated with a real scene according to one aspect of the present invention, comprising a network device 1 and a plurality of user equipment 2 connected to the network device 1 via network. Herein, the network device 1 may be connected to a plurality of user equipment 2 via network, and obtain an access request sent by a user through the user equipment 2 and based on a scene image associated with a real scene; perform match query in a shared object repository based on the scene image so as to obtain one or more shared objects corresponding to the access request; and provide said one or more shared objects to the user equipment 2. Here, the network includes, but not limited to, Internet, Wide Area Network, Metropolitan Area Network, Local Area Network, VPN network, and Mobile Ad Hoc network, and the like.

Furthermore, the network device 1 includes, but not limited to, a network host, a single network server, a plurality of network server clusters or a cloud formed by a plurality of servers. Here, the cloud is formed by a considerable number of computers or network servers based on cloud computing, wherein cloud computing is one kind of distributed computing and a super virtual computer formed by a group of computer clusters loosely coupled. The user equipment 2 includes, but not limited to, any kind of electronic product that may perform human-machine interaction with a user through a keyboard, a mouse, a remote controller, a touch pad, or a handwriting device, and the like, for example, a computer, a mobile phone, a camera, a video camera, a PDA, a pocket PC, an IPTV or MP4, and the like. The communications between the network device 1 and the user equipment 2 are independent from each other, including, but not limited to, packet data transmission based on TCP/IP protocol, UDP protocol, and the like.

Those skilled in the art should understand that the above network device 1, user equipment 2, and the network or the communication manners connecting them, are only exemplary, and other existing or future possibly emerging network devices, user equipment, or networks, or communications manners, if applicable to the present invention, should also be included within the protection scope of the present invention, which are incorporated here by reference.

Those skilled in the art should further understand that the number of various network elements, which are shown in FIG. 1 only for brevity, might be less than the number of various network elements in a real network, but such omission is undoubtedly preconditioned with not affecting clear and sufficient disclosure of the present invention.

For the sake of brevity, one of the user equipment 2 will be used as an example to depict the present invention hereinafter. Those skilled in the art should understand that the network device 1 may simultaneously interact with a plurality of user equipment 2 and obtain an access request based on a scene image associated with a real scene from different user equipment 2; perform match query in a shared object repository based on the scene image so as to obtain one or more shared objects corresponding to the access request; and provide said one or more shared objects to the corresponding user equipment 2.

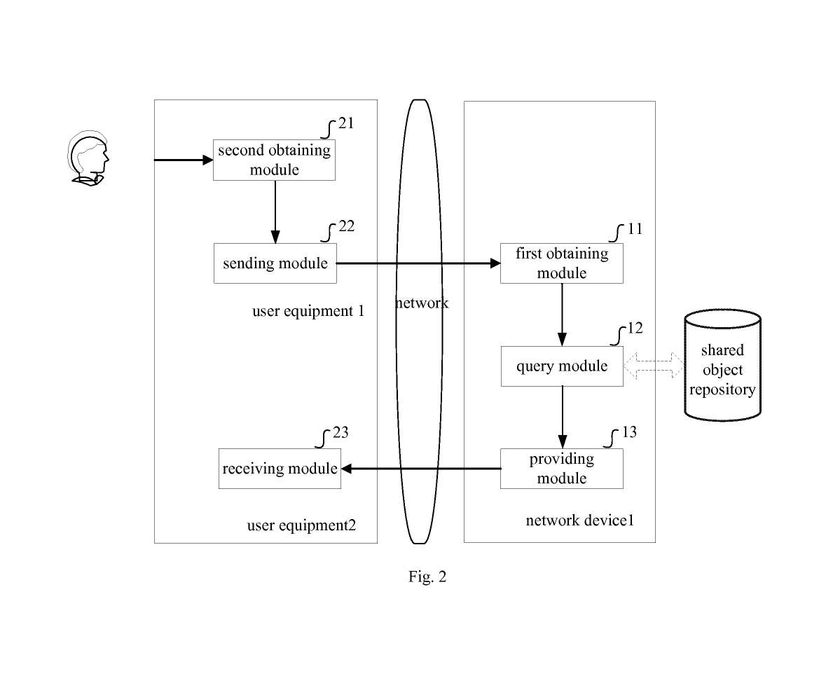

FIG. 2 shows a diagram of devices for obtaining a shared object associated with a real scene according to one aspect of the present invention, wherein a network device 1 comprises first obtaining module 11, query module 12, and providing module 13; user equipment 2 comprises second obtaining module 21, sending module 22, and receiving module 23.

The modules of the network device 1 and the user equipment 2 cooperate with each other to implement obtaining a shared object associated with a real scene. Specifically, the second obtaining module 21 in the user equipment 2 obtains a scene image corresponding to a real scene, the scene image being provided by a user through the user equipment 2; the sending module 22 sends an access request based on the scene image to the network device 1; the first obtaining module 11 in the network device 1 obtains an access request sent by the user through the user equipment and based on the scene image corresponding to the real scene; the query module 12 performs match query in a shared object repository based on the scene image so as to obtain one or more shared objects corresponding to the access request; the providing module 13 provides said one or more shared objects to the user equipment 2; the receiving module 23 in the user equipment 2 receives said one or more shared objects based on the access request, the shared objects being sent from the network device 1. Preferably, the above modules work constantly therebetween. Here, those skilled in the art should understand that “constantly” means that the above modules perform obtaining the scene image, sending and receiving the access request, and matching, providing, and receiving shared objects according to a preset or real-time adjusted working mode, respectively, until the user stops providing the scene image through the user equipment 2 in a relatively long time.

More specifically, the second obtaining module 21 of the user equipment 2 obtains a scene image corresponding to a real scene, the scene image being provided by a user through the user equipment. Specifically, the manner in which a user provides a scene image includes, but not limited to, invoking an image containing a real scene in a file folder, application, or client software in the user equipment 2, or shooting or scanning an image containing a real scene. For example, the user may shoot a picture with “Shanghai Landmark Plaza” as a background using a mobile phone, or draw a building picture with “Xujiahui Catholic Church” as an object using an electronic drawing tool, or invoke an existing scene picture stored in a computer, or the user can provide a scene picture of the scene just by opening the camera and zeroing the target without shooting or recording a video; afterwards, the second obtaining module 21 obtains the scene image provided by the user through, for example, invoking an application program interface (API) provided by the user equipment 2, or invoking a save program in the drawing program, or invoking a image capturing application in the video program, and the like. Those skilled in the art should understand that the above manners of obtaining a scene image are only exemplary, and other existing or future possibly emerging manners of obtaining a scene image, if applicable to the present invention, should also be included within the protection scope of the present invention, which are incorporated here by reference.

The sending module 22 sends an access request based on the scene image to the network device. Specifically, the sending module 22 generates an access request based on the scene image according to the scene image corresponding to the real scene, the scene image being provided by the user through the user equipment and obtained by the second obtaining module 21, and then the sending module 22 sends the access request based on the scene image to the network device 1 through, for example, building a channel link with the network device 1, or invoking the application program interface (API) provided by the network device 1 once or for more times, or other communications manners. Preferably, the access request includes the scene image. More preferably, the access request may be sent automatically, for example, automatically sending the access request when the client captures an action of the camera; the sending may also be triggered after the user clicks onto a certain button, for example, the user selects a “request” option on a menu or selects an “access” button in the user equipment 2, and etc. Those skilled in the art should understand that the above manners of sending an access request are only exemplary, and other existing or future possibly emerging manners of sending an access request, if applicable to the present invention, should also be included within the protection scope of the present invention, which are incorporated here by reference.

The first obtaining module 11 in the network device 1 obtains an access request based on a scene image corresponding to a real scene, the access request being sent from a user through user equipment 2. Specifically, the first obtaining module 11 obtains, through, for example, the API or other agreed communication manners as above mentioned, the access request generated based on the scene image, obtained by the second obtaining module 21, and sent by the sending module 22. Those skilled in the art should understand that the above manners of obtaining an access request are only exemplary, and other existing or future possibly emerging manners of obtaining an access request, if applicable to the present invention, should also be included within the protection scope of the present invention, which are incorporated here by reference.

The query module 12 performs match query in a shared object repository based on the scene image so as to obtain one or more shared objects corresponding to the access request. Specifically, according to the access request based on the scene image and obtained by the first obtaining module 11, the query module 12 parses the scene image corresponding to the real scene, and performs match query in a shared object repository, for example, based on the content, tag, keyword and other information of the scene image, so as to obtain one or more shared objects corresponding to the access request. For example, the network device 1 may build or update the shared object repository, based on object sharing operations of a considerable number of users with respect to a shared object of a real scene, in conjunction with a scene identification corresponding to the object sharing operation in the shared object repository. Therefore, the shared object repository not only stores a great amount of shared objects and scene identifications (the forms of storing include, but not limited to, words, document, picture, etc.) and meanwhile stores mapping relationships between the shared object and the scene identification. Preferably, the forms of storing the mapping relationships include, but not limited to: a) storing as independent data, b) storing the shared objects and scene identifications into corresponding tables, c) storing the scene identifications as state information of the shared objects (for example, tags of the shared objects). For example, when a user selects sharing “discount information” of “Buynow Plaza,” the network device 1 would store, in the object repository, the “discount information” as a shared object, the “Buynow Plaza” as a scene identification, and the corresponding relationship between the “discount information” and the “Buynow Plaza” as a mapping relationship between the shared object and the scene identification. Afterwards, once a user sends an access request corresponding to the “Buynow Plaza,” the query module 12 may immediately perform match query in the shared object repository based on the mapping relationships between the shared objects and the scene identifications, obtaining one or more shared objects that have a mapping relationship with “Buynow Plaza,” such as “discount information,” “promotion information,” or “new product information,” and the like. Those skilled in the art should understand that the above manner of obtaining a shared object is only exemplary, and other existing or future possibly emerging manners of obtaining a shared object, if applicable to the present invention, should also be included within the protection scope of the present invention, which are incorporated here by reference.

The providing module 13 provides said one or more shared objects to the user equipment 2. Specifically, the providing module 13, according to said one or more shared objects obtained by the query module 12, for example, through an image overlapping or page processing technology, provides said one or more shared objects to the user equipment 2, for example, overlapping and displaying these shared objects on a scene image, or generating a page with respect to these shared objects using JSP, ASP or other page processing technologies to provide to the user equipment 2. Continue the above example. When the query module 12 obtains a shared object corresponding to the “Buynow Plaza,” the providing module 13 would provide the shared object, for example, “discount information,” “promotion information” or “new product information” to the user equipment 2. Preferably, the providing module 13 may send the shared object to the user via SMS, MMS or email, or by packaging the shared object into a data packet, and may also directly display the shared object on the user screen in the manner of the original size or thumbnail of the shared object. More preferably, the manner of providing may be providing all shared objects one time to the user, or that the providing module 13 provides a previous or next shared object when the user presses a particular functional key to select. The particular function keys, for example, may be “+” and “−,” “↑” and “↓.” More preferably, the number of said one or more shared objects provided may be default or set by the user. Those skilled in the art should understand that the above manner of providing a shared object is only exemplary, and other existing or future possibly emerging manners of providing a shared object, if applicable to the present invention, should also be included within the protection scope of the present invention, which are incorporated here by reference.

The receiving module 23 receives one or more shared objects based on the access request, said one ore more shared objects being sent from the network device 1. Specifically, the receiving module 23 receives one or more shared objects that are obtained by the query module 12 and provided by the providing module 13. Preferably, the manner of receiving may be automatic, or be triggered by a user clicking onto a button. For example, the user equipment 2 may first query whether a user receives a shared object through a dialog box, and after the user selects “yes,” the receiving module 23 would immediately start receiving. More preferably, after the receiving module 23 receives the shared object, it may automatically open the shared object, or store it into the user equipment 2 and wait for the user to open by for example opening an inbox or by decompression and the like. Continue the above example. If the “discount information,” “promotion information” or “new product information” and the like is provided by SMS, the user may receive it by opening the inbox; if the shared object is provided in a data packet, then the user may receive it through download and decompression; if the shared object is directly displayed on the screen, then the user does not need to receive it otherwise. Preferably, the manner of displaying the shared object may be displaying it in a new page or overlapping it on the original screen in a suspending manner. More preferably, when overlapped on the original screen in a suspending manner, the shared object may be displayed in a certain fixed region of the page or may be displayed at the location set by the user. Continue the above example. When the providing module 13 directly displays the “discount information,” “promotion information” or “new product information” on the user's screen, the receiving module 23 may display it in a new page, or overlap it above, under, or left or right of the original “Buynow Plaza” image with a suspending window. Those skilled in the art should understand that the above manners of receiving a shared object is only exemplary, and other existing or future possibly emerging manners of receiving a shared object, if applicable to the present invention, should also be included within the protection scope of the present invention, which are incorporated here by reference.

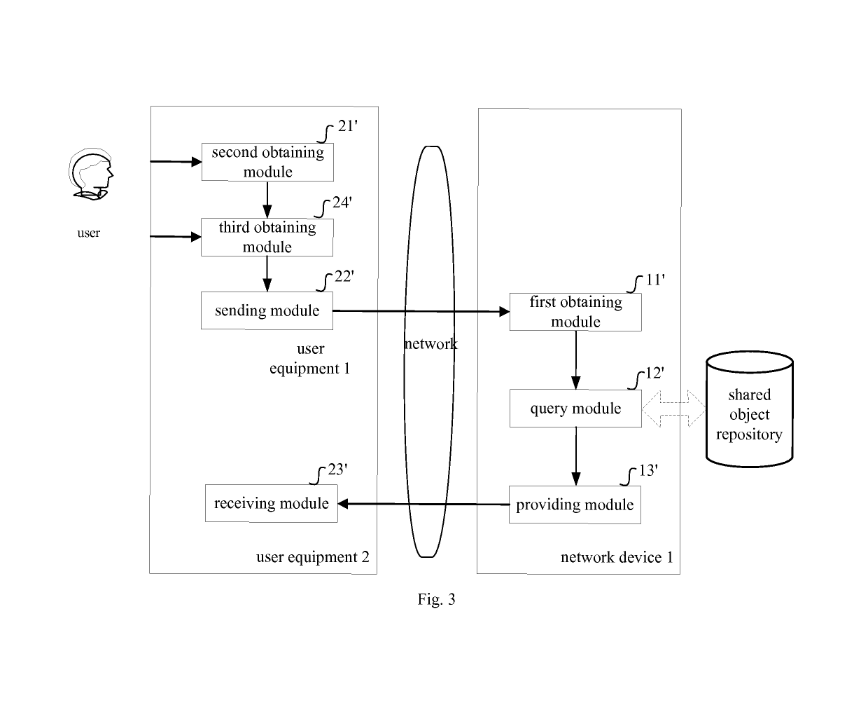

FIG. 3 shows a diagram of devices for obtaining a shared object associated with a real scene according to one preferred embodiment of the present invention, wherein the user equipment 2 may further comprise third obtaining module 24′. Herein, first obtaining module 11′, query module 12′ and providing module 13′ in the network device 1 are identical to corresponding modules 11-13 as shown in FIG. 2, respectively; second obtaining module 21′, sending module 22′ and receiving module 23′ in the user equipment 2 are identical to corresponding modules 21-23 as shown in FIG. 2, respectively. Therefore, they will not be detailed here, but are incorporated here by reference.

Herein, the third obtaining module 24′ in the user equipment 2 obtains scene-related information corresponding to the real scene; the sending module 22′ sends the access request to the network device 1, wherein the access request includes the scene-related information; the first obtaining module 11′ in the network device 1 obtains the access request; the query module 12′ performs query match in the shared object repository based on the scene image and the scene-related information so as to obtain one or more shared objects. Specifically, the third obtaining module 24′ obtains scene-related information corresponding to the real scene, for example, description information, keyword information and the like of the real scene, through for example, a locating service of the real scene, or receiving a user's annotation of the scene, or performing image recognition on the scene image, and the like manner; and then the sending module 22′ generates an access request based on the scene image obtained by the second obtaining module 21′ and the scene-related information obtained by the third obtaining module 24′, and sends the access request to the network device 1; after the first obtaining module 11′ obtains the access request, the querying module 12′ parses the scene image and the scene-related information from the access request, and performs match query in the shared object repository based on the tag or keyword of the scene image in conjunction with the content in the scene-related information, thereby obtaining said one or more shared objects. Here, the scene-related information may not only be obtained independently by the network device 1, but also may be the scene-related information recorded by the user equipment 2 or obtained by other product or a third-party device. For example, the scene-related information may be a geographical location of the scene “No. 333, Caoxi Beilu, Xuhui District, Shanghai” obtained by the third obtaining module 24′ through a global positioning service (GPS), or “Xujiahui Electronics Mall” obtained by receiving an annotation added by a user, or a scene shape “Bird's Nest” obtained through image recognition processing, and etc. Those skilled in the art should understand that the above manners of obtaining scene-related information is only exemplary, and other existing or future possibly emerging manners of obtaining scene-related information, if applicable to the present invention, should also be included within the protection scope of the present invention, which are incorporated here by reference.

Preferably, the scene-related information includes, but not limited to:
location information of the real scene;
descriptive information of the real scene;
symbolic information of the real scene.

Specifically, the scene-related information may help the query module 12′ to more accurately determine a real scene corresponding to an access request, which is based on a scene image corresponding to the real scene, thereby obtaining one or more shared objects corresponding to the access request. With the location information as an example, when the third obtaining module 24′ obtains the scene-related information “No. 333, Caoxi Beilu, Xuhui District, Shanghai” through a global positioning service (GPS), the query module 12 can determine that the real scene is “Xujiahui Buynow Plaza,” based on the content, tag and keywords of the scene image in conjunction with the scene-related information, thereby obtaining one or more corresponding shared objects. With the descriptive information as an example, when the third obtaining module 24′ obtains that the scene-related information is “Xujiahui Electronics Mall” through an annotation added by the user, the query module 12′ can also determine that the real scene is “Xujiahui Buynow Plaza,” based on the content, tag and keywords of the scene image in conjunction with the scene-related information. With the symbolic information as an example, when the third obtaining module 24′ obtains that the scene-related information is “Bird's Nest” through image recognition processing, the query module 12′ can determine that the real scene is the “National Stadium”, based on the content, tag and keywords of the scene image in conjunction with the scene-related information. Those skilled in the art should understand that the above scene-related information is only exemplary, and other existing or future possibly emerging scene-related information, if applicable to the present invention, should also be included within the protection scope of the present invention, which are incorporated here by reference.

More preferably, the scene-related information includes location information of the real scene, wherein the third obtaining module 24′ in the user equipment 2 obtains the location information corresponding to the real scene through a location providing service. Preferably, the location information includes, but not limited to: 1) absolute geographical location information, for example, the longitude and latitude of the real scene; 2) relative geographical location information of the scene, for example, “located at the intersection between Hongkou District and Zhabei District.” More preferably, the manner in which the third obtaining module 24′ obtains the location information corresponding to the real scene includes, but not limited to: performing global positioning system (GPS) positioning, cellular base station positioning or location server positioning and the like to the real scene. For example, the third obtaining module 24′ obtains that the location information of a scene is “No. 333, Caoxi Beilu, Xuhui District, Shanghai”, through GPS positioning, and then the sending module 22′ sends an access request including the location information to the network device 1; the query module 12′ finds the shared object corresponding to “Xujiahui Buynow Plaza” through match queries based on the location information. Those skilled in the art should understand that the above manners of obtaining location information are only exemplary, and other existing or future possibly emerging manners of obtaining location information, if applicable to the present invention, should also be included within the protection scope of the present invention, which are incorporated here by reference.

Those skilled in the art should understand that the above second obtaining module and third obtaining module are only examples. In practice, they may be two independent modules or integrated into one module.

In a preferred embodiment (see FIG. 2), the network device 1 may further comprise identifying module (not shown) which performs image recognition processing on the scene image so as to obtain image-related information corresponding to the scene image, wherein the query module 12 performs match query in the shared object repository based on the scene image and the image-related information so as to obtain said one or more shared objects. Specifically, after the first obtaining module 11 obtains from the sending module 22 an access request based on the scene image corresponding to the real scene, the network device 1 parses the scene image therefrom, and then the identifying module performs to the scene image image recognition, including, but not limited to, characteristic recognition, word recognition, or edge recognition, thereby obtaining image-related information corresponding to the scene image, for example, background information, descriptive information of the image, and the like. Afterwards, the query module 12 performs match query in the shared object repository based on the content of the image-related information to obtain said one or more shared objects. For example, if the identifying module identifies that the scene image sent by the user is “Buybow Plaza,” then the query module 12 would immediately perform match query in the shared object repository based on the mapping relationships between shared objects and scene identifications, thereby obtaining one or more shared objects with mapping relationships with “Buynow Plaza.” Those skilled in the art should understand that the above manners of obtaining image-related information is only exemplary, and other existing or future possibly emerging manners of obtaining image-related information, if applicable to the present invention, should also be included within the protection scope of the present invention, which are incorporated here by reference.

More preferably, the image-related information includes at least one of the following:
background information corresponding to the scene image;
object information corresponding to the scene image;
keyword information corresponding to the scene image.
   Specifically, the image recognition process includes, but limited to, performing characteristic recognition, word recognition or edge recognition to the scene image. With edge recognition and background information as example, if a user sends a picture with “Shanghai Oriental Pearl” as the background, then the identifying module first positions the intersection line between the building and other background, and then judges that the edge contour line is a combination of three “spheres” with different dimensions but arranged orderly and several “cylinders,” thereby deriving background information that the building is “Shanghai Oriental Pearl.” With word recognition and object information as example, if a user sends a picture shot with “ [symbol] [symbol] ” (Shanghai Meilongzhen Guangchang) signboard as a shooting object, the identifying module first extracts the words in the picture, and immediately recognizes “ [symbol] ” (Shang), “ [symbol] ” (hai), “ [symbol] ” (Mei), “ [symbol] ” (long), “ [symbol] ” (zhen), “ [symbol] ” (Guang), “ [symbol] ” (chang) through word recognition, thereby deriving object information that the scene is “ [symbol] .” With characteristic recognition and keyword information as an example, if the user sends a picture containing “Xujiahui Catholic Church,” since the catholic church has a more eye-catching character than other buildings, for example, spire, long lines, densely arranged, the identifying module may recognize, through these features, the characteristic information that the scene is “Xujiahui Catholic Church.” Afterwards, the query module 12 can perform match query in the shared object repository based on the obtained image-related information, for example, “Shanghai Oriental Pearl,” “ [symbol] ” or “Xujiahui Catholic Church.” Those skilled in the art should understand that the above image-related information is only exemplary, and other existing or future possibly emerging image-related information, if applicable to the present invention, should also be included within the protection scope of the present invention, which are incorporated here by reference.

More preferably (see FIG. 3), the query module 12′ performs match query in the shared object repository based on the scene image and the scene-related information, in conjunction with the image-related information, thereby obtaining said one or more shared objects. Specifically, the query module 12′ performs match query in the shared object repository based on the scene image obtained by the first obtaining module 11′ and the scene-related information (e.g., location information, descriptive information, symbolic information) obtained by the third obtaining module 24′, in conjunction with the image-related information (e.g., background information, object information, keyword information) obtained by the identifying module. For example, the first obtaining module 11′, besides the scene image obtained from the second obtaining module 21′, also obtains the scene-related information from the third obtaining module 24′, for example, the location information “No. 333, Caoxi Beilu, Xuhui District, Shanghai” obtained through GPS positioning, and meanwhile the identifying module derives, through the image recognition technology, that the background information of the scene image is “Xujiahui Buynow.” And then the query module 12′ first matches the location information, and when the location information is successfully matched with the location information of the scene identification “Xujiahui Buynow Plaza,” further matches the image-related information, where a certain error-tolerant mechanism is allowed with respect to the matching degree of the image-related information. For example, the network device 1 may be set such that if the location information is completely identical and 80% of the image-related information matches, then a shared object corresponding to the scene identification is obtained. Those skilled in the art should understand that the above manner of obtaining a shared object is only exemplary, and other existing or future possibly evolving manners of obtaining a shared object, if applicable to the present invention, should also be included within the protection scope of the present invention, which are incorporated here by reference.

In another preferred embodiment (see FIG. 2), the providing module 13 provides said one or more shared objects to the user equipment based on object state information corresponding to said one or more shared objects. Specifically, the providing module 13 provides said one or more shared objects to the user equipment 2, based on said one or more shared objects obtained by the query module 12, in conjunction with the object state information corresponding to said one or more shared objects, for example, tag information, category information, layer information, attribute information, and layout information of the shared object. For example, the network device 1 may establish or update the shared object repository, based on object sharing operations of a considerable number of users with respect to shared objects of one or more real scenes, in conjunction with object state information of the shared object. Therefore, not only the shared object repository stores a considerable number of shared objects, but also different shared objects are of their own different object state information. Specifically, the network device 1 may store different objects into different categories or tags according to different contents and categories of shared objects; therefore, the providing module 13 can provide one or more shared objects to the user based on different categories or tags. Those skilled in the art should understand that the above manner of providing a shared object is only exemplary, and other existing or future possibly emerging manners of providing a shared object, if applicable to the present invention, should also be included within the protection scope of the present invention, which are incorporated here by reference.

Preferably, the object state information includes at least one of the following:
tag information of the shared object;
category information of the shared object;
layer information of the shared object;
attribute information of the shared object;
layout information of the shared object.
   Here, the tag information includes, but not limited to, scene identification mapped to a shared object. For example, the tag of “discount information a” is “Landmark Plaza,” the tag of “discount information b” is “Buynow Plaza,” and so forth. The category information includes, but not limited to, the kind of a shared object, for example, “article information,” “service information,” “traffic information.” The layer information includes, but not limited to, displaying layer of the shared object on a screen. For example, the background computer may set shared objects of different categories on different layers. Continue the above example. Suppose the scene image of “Buynow” as initially seen on the screen is the first layer, then the shared object of the “article information” category is overlapped and displayed on the first layer, i.e., the second layer; that of the “service information” category is displayed on the third layer, and so forth, which facilitates the user to choose shared objects of the appropriate category. The attribute information includes, but not limited to, type (for example, text, image, or a combination of text and image) of the shared object, the content, size, or shape of the shared object, and the like. The layout information includes, but not limited to, displaying location of a shared object on the screen. For example, the background computer may set shared objects of different categories on different locations of the screen. Continue the above example. Suppose it is the scene image of “Buynow Plaza” that is initially displayed on the screen, then the shared object of the “article information” category is displayed above the scene image, while that of the “service information” one is displayed below the scene image, and so forth, for the user to distinguish the shared objects. Preferably, the object state information of the shared object may not only be independently obtained by the network device 1, for example, automatically set in the ground according to image recognition, content recognition or location recognition; but also the object state information may be received from what the user equipment 2 records, for example, set by the user per se; or the object state information may be received from the object state information of the shared object obtained by other product or a third party device. Those skilled in the art should understand that the above object state information is only exemplary, and other existing or future possibly emerging object state information, if applicable to the present invention, should also be included within the protection scope of the present invention, which are incorporated here by reference.

In a further preferred embodiment (see FIG. 2), the query module 12 performs match query in the shared object repository based on the scene image in conjunction with user-related information of the user, thereby obtaining said one or more shared objects. Specifically, the query module 12 parses the scene image corresponding to the real scene from the access request of the scene image obtained by the first obtaining module 11, performs match query in the shared object repository based on the scene image in conjunction with the user-related information of the user, for example, basic attributes, geographical location, and historical operation log and the like of the user, so as to obtain one or more shared objects corresponding to the access request. For example, for men, women, children, the old, etc., when the scene image provided by them includes “** shopping mall,” their actual needs differ greatly, wherein men users may feel more interested in sports products, men clothes, and electronics; women users may feel more interested in skincare/cosmetics products, women clothes; children may feel more interested in children clothes, children readings, and cartoons; while old users may feel more interested in clothes for the old, healthcare products. Of course, a user's personal background (e.g., education background, life background, religion background) may also become factors affecting the obtaining of shared objects. For example, a user with overseas study or living background feels more interested in imported articles than a general user. Besides, a user's historical operation log may also become indication information for determining a shared object. Here, the user-related information may not only be obtained independently by the network device 1, but also may be the user-related information recorded by the user equipment 2 or the user-related information obtained by other product or a third-party device. Those skilled in the art should understand that the above manner of obtaining a shared object is only exemplary, and other existing or future possibly emerging manners of obtaining a shared object, if applicable to the present invention, should also be included within the protection scope of the present invention, which are incorporated here by reference.

More preferably, the user-related information includes at least one of the following:
basic attributes of the user;
geographical location of the user;
historical operation log of the user.
   Herein, the user's basic attributes include, but not limited to, personal background information pre-entered by the user (for example, gender, age, religion, nationality, education degree, etc.), and the user's preference information, etc.; the user's geographical location includes, but not limited to, the user's absolute geographical location (e.g., longitude, latitude), or the user's relative geographical location (e.g., the intersection between which district and which district); the user's historical operation log includes, but not limited to, the user's purchase history log, viewing log, etc. The query module 12 performs match query in a shared object repository based on the scene image, in conjunction with the user-related information of the user, so as to obtain one or more shared objects corresponding to the access request. For example, when a user scans a scene image of Carrefour Supermarket, if the user's geographical location shows that he/she is located in the Wujiaochang region and the user is elderly and likes buying discount articles, then the query module 12 can obtain the discount information of Carrefour Supermarket in the Wujiaochang region, based on the above user information. When the user's geographical location shows that he/she is in Wanli region and the user is relatively young and has an experience of living abroad, then the query module 12 can obtain the imported articles information of Carrefour Supermarket in the Wanli region, based on the above user information. Those skilled in the art should understand that the above user-related information is only exemplary, and other existing or future possibly emerging user-related information, if applicable to the present invention, should also be included within the protection scope of the present invention, which are incorporated here by reference.

In one preferred embodiment (see FIG. 2), the network device 1 further comprises first updating module (not shown). The first updating module obtains an object modification operation performed by the user to at least one of said one or more shared objects; and builds or updates the shared object repository based on the object modification operation in conjunction with a scene identification corresponding to the object modification operation in the shared object repository. Specifically, the first updating module, according to interaction with the user equipment 2 and the user, obtains an object modification operation to at least one thereof after the user receives one or more shared objects through the receiving module 23, for example, modifying the content, shape, and layer and the like of the shared object, and builds or updates the shared object repository, based on scene identification corresponding to the object modification operation in the shared object repository. For example, when the user obtains a shared object in the shared object repository through shooting and uploading a scene image, the user may modify the shared object and opt to continue updating it to the shared object repository. Then the shared object as subsequently obtained by a user is just the modified shared object. Preferably, the modification rights of the shared object may be set by the user or by the background computer. More preferably, when setting the modification rights, the user or background computer may limit the body that could modify the shared object, for example, only the user per se can modify the shared object, or limit the shared object state information that may be modified, for example, only the layer information of the shared object may be modified. Those skilled in the art should understand that the above manner of building or updating a shared object repository is only exemplary, and other existing or future possibly evolving manners of building or updating a shared object repository, if applicable to the present invention, should also be included within the protection scope of the present invention, which are incorporated here by reference.

In another preferred embodiment (see FIG. 2), the network device 1 further comprises second updating module (not shown). The second updating module obtains object sharing operations performed by a number of users to shared object of one or more real scenes; and builds or updates the shared object repository based on the object sharing operations in conjunction with scene identifications corresponding to the object sharing operations in the shared object repository. Specifically, the second updating module, according to interaction with the user equipment 2 and the user, obtains object sharing operations of a considerable number of users, and records and updates the object repository based on the scene identifications corresponding to the object sharing operations in the shared object repository, for example, the preset information and scene identification entered by the users. Therefore, the shared object repository not only stores a great amount of shared objects and scene identifications (the forms of storing include, but not limited to, words, document, picture, etc.) and meanwhile stores mapping relationships between the shared objects and the scene identifications. Preferably, the forms of storing the mapping relationships include, but not limited to: a) storing as independent data; b) storing the shared objects and scene identifications into a corresponding table; c) storing the scene identifications as state information of the shared objects (for example, the tags of the shared objects). For example, if a user wants to reserve a virtual note at some place in advance, he may edit the content of the note and a corresponding address in advance and store it in the shared object repository. Those skilled in the art should understand that the above manner of building or updating a shared object repository is only exemplary, and other existing or future possibly evolving manners of building or updating a shared object repository, if applicable to the present invention, should also be included within the protection scope of the present invention, which are incorporated here by reference.

Those skilled in the art should understand that the above first and second updating modules are only examples. In practice, they may be two individual modules or integrated into one module.

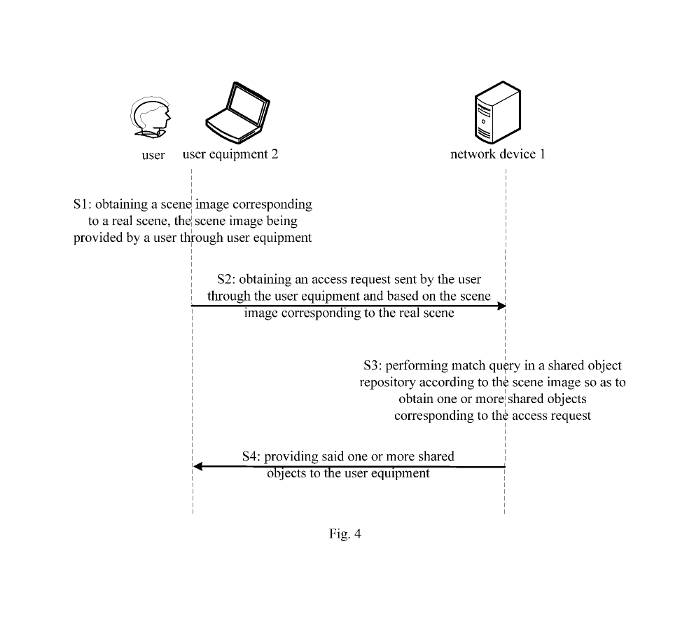

FIG. 4 shows a flow chart of a method for obtaining a shared object associated with a real scene according to another aspect of the present invention.

The steps of the network device 1 and the user equipment 2 cooperate with each other to implement obtaining a shared object associated with a real scene. Specifically, in step S1, the user equipment 2 obtains a scene image corresponding to a real scene, the scene image being provided by the user through user equipment 2; in step S2, the user equipment 2 sends an access request based on the scene image to the network device 1; the network device 1 obtains the access respect sent by the user through the user equipment and based on the scene image corresponding to the real scene; in step S3, the network device 1 performs match query in a shared object repository based on the scene image so as to obtain one or more shared objects corresponding to the access request; in step S4, the network device 1 provides said one or more shared objects to the user equipment 2; the user equipment 2 receives one or more shared objects based on the access request, said one or more shared objects being sent from the network device 1. Preferably, the above steps work constantly therebetween. Here, those skilled in the art should understand that “constantly” means that the above steps perform obtaining the scene image, sending and receiving the access request, and matching, providing, and receiving shared objects according to a preset or real-time adjusted working mode, respectively, until the user stops providing the scene image through the user equipment 2 in a relatively long time.

More specifically, in step S1, the user equipment 2 obtains a scene image corresponding to a real scene, the scene image being provided by a user through the user equipment 2. Specifically, the manner in which a user provides a scene image includes, but not limited to, invoking an image containing a real scene in a file folder, application, or client software in the user equipment 2, or shooting or scanning an image containing a real scene. For example, the user may shoot a picture with “Shanghai Landmark Plaza” as a background using a mobile phone, or draw a building picture with “Xujiahui Catholic Church” as an object using an electronic drawing tool, or invoke an existing scene picture stored in the computer, or the user can provide a scene picture of the scene just by opening the camera and zeroing the target without shooting or recording a video; afterwards, in step S1, the user equipment 2 obtains the scene image provided by the user through, for example, invoking an application program interface (API) provided by the user equipment 2, or invoke a save program in the drawing program, or invoking a image capturing application in the video program, and the like. Those skilled in the art should understand that the above manners of obtaining a scene image are only exemplary, and other existing or future possibly emerging manners of obtaining a scene image, if applicable to the present invention, should also be included within the protection scope of the present invention, which are incorporated here by reference.

In step S2, the user equipment 2 sends an access request based on the scene image to the network device 1. Specifically, in step S2, the user equipment 2 generates an access request based on the scene image according to the scene image corresponding to the real scene, the scene image being provided by the user through the user equipment and obtained in step S1, and then in step S2, the user equipment 2 sends the access request based on the scene image to the network device 1 through, for example, building a channel link with the network device 1, or invoking the application program interface (API) provided by the network device 1 once or for more times, or other communications manners. Preferably, the access request includes the scene image. More preferably, the access request may be sent automatically, for example, automatically sending the access request when the client captures an action of the camera; the sending may also be triggered after the user clicks onto a certain button, for example, the user selects a “request” option on a menu or selects an “access” button in the user equipment 2, and etc. Those skilled in the art should understand that the above manners of sending an access request are only exemplary, and other existing or future possibly emerging manners of sending an access request, if applicable to the present invention, should also be included within the protection scope of the present invention, which are incorporated here by reference.

The network device 1 obtains an access request based on a scene image corresponding to a real scene, the access request being by the user through the user equipment 2. Specifically, in step S2, the network device 1 obtains an access request that is generated based on the scene image obtained in step S1 and sent by the user equipment 2 for example through the aforementioned API or other agreed communication manner. Those skilled in the art should understand that the above manners of obtaining an access request are only exemplary, and other existing or future possibly emerging manners of obtaining an access request, if applicable to the present invention, should also be included within the protection scope of the present invention, which are incorporated here by reference.

In step S3, the network device 1 performs match query in a shared object repository based on the scene image so as to obtain one or more shared objects corresponding to the access request. Specifically, in step S3, according to the access request based on the scene image and obtained in step S2, the network device 1 parses the scene image corresponding to the real scene, performs match query in a shared object repository, for example, based on the content, tag, keyword and other information of the scene image so as to obtain one or more shared objects corresponding to the access request. For example, the network device 1 may build or update the shared object repository based on object sharing operations of a considerable number of users with respect to a shared object of a real scene in conjunction with a scene identification corresponding to the object sharing operation in the shared object repository. Therefore, the shared object repository not only stores a great amount of shared objects and scene identifications (the forms of storing include, but not limited to, words, document, picture, etc.) and meanwhile sores mapping relationships between the shared objects and the scene identifications. Preferably, the forms of storing the mapping relationships include, but not limited to: a) storing as independent data, b) storing the shared objects and scene identifications into a corresponding table; c) storing the scene identifications as state information of the shared objects (for example, the tags of the shared objects). For example, when a user selects sharing “discount information” of “Buynow Plaza,” the network device 1 would store, in the object repository, the “discount information” as a shared object, the “Buynow Plaza” as a scene identification, and the correspondence relationship between the “discount information” and the “Buynow Plaza” as a mapping relationship between the shared object and the scene identification. Afterwards, once a user sends an access request corresponding to the “Buynow Plaza,” in step S3, the network device 1 may immediately perform match query in the shared object repository based on the mapping relationships between the shared objects and the scene identifications, obtaining one or more shared objects that have a mapping relationship with “Buynow Plaza,” such as “discount information,” “promotion information,” or “new product information,” and the like. Those skilled in the art should understand that the above manner of obtaining a shared object is only exemplary, and other existing or future possibly emerging manners of obtaining a shared object, if applicable to the present invention, should also be included within the protection scope of the present invention, which are incorporated here by reference.

In step S4, the network device 1 provides said one or more shared objects to the user equipment 2. Specifically, in step S4, the network device 1, according to said one or more shared objects obtained in step S3, for example, through an image overlapping or page processing technology, provides said one or more shared objects to the user equipment 2, for example, overlap displaying these shared objects on a scene image, or generating a page with respect to these shared objects using JSP, ASP or other page processing technologies to provide to the user equipment 2. Continue the above example. When the network device 1 obtains a shared object corresponding to the “Buynow Plaza” in step S3, the network device 1 would provide the shared object, for example, “discount information,” “promotion information” or “new product information” to the user equipment 2. Preferably, in step S4, the network device 1 may send the shared object through SMS, MMS, or email, or through packaging the shared object into a packet, to the user, or may directly display the shared object on the user screen in the manner of the original size or thumbnail of the shared object. More preferably, the manner of providing may be providing all shared objects one time to the user, or that the network device 1 provides a previous or next shared object when the user presses a particular functional key to select. The particular functional keys, for example, may be “+” and “−,” “↑” and “↓.” More preferably, the number of said one or more shared objects provided may be default or set by the user. Those skilled in the art should understand that the above manner of providing a shared object is only exemplary, and other existing or future possibly emerging manners of providing a shared object, if applicable to the present invention, should also be included within the protection scope of the present invention, which are incorporated here by reference.

The user equipment 2 receives one or more shared objects based on the access request, said one ore more shared objects being sent from the network device 1. Specifically, in step S4, the user equipment 2 receives one or more shared objects obtained in step S3 and provided from the network device 1. Preferably, the manner of receiving may be automatic, or be triggered by a user clicking onto a button. For example, the user equipment 2 may first query whether a user receives a shared object through a dialog box, and after the user selects “yes,” the user equipment 2 would immediately start receiving. More preferably, after the user equipment 2 receives the shared object, it may automatically open the shared object or store it into the user equipment 2 and wait for the user to open by for example opening an inbox or by decompression and the like. Continue the above example. If the “discount information,” “promotion information” or “new product information” and the like is provided by SMS, then the user may receive it by opening the inbox; if the shared object is provided in a data packet, then the user may receive it through download and decompression; if the shared object is directly displayed on the screen, then the user does not need to receive it otherwise. Preferably, the manner of displaying the shared object may be displaying it in a new page or overlapping it on the original screen in a floating manner. More preferably, when overlapped on the original screen in a suspending manner, the shared object may be displayed in a certain fixed region of the page or may be displayed at the location set by the user. Continue the above example. When the user equipment 2 directly displays the “discount information,” “promotion information” or “new product information” on the user's screen in step S4, the user equipment 2 may display it in a new page, or overlap it above, under, or left or right of the original “Buynow Plaza” image with a suspending window. Those skilled in the art should understand that the above manners of receiving a shared object is only exemplary, and other existing or future possibly evolving manners of receiving a shared object, if applicable to the present invention, should also be included within the protection scope of the present invention, which are incorporated here by reference.

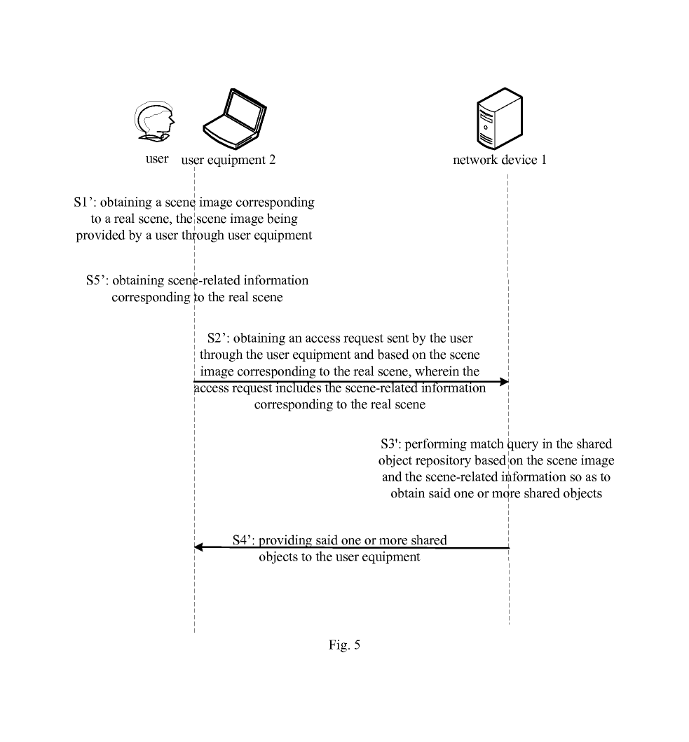

FIG. 5 shows a flowchart of a method of obtaining a shared object associated with a real scene according to one preferred embodiment of the present invention, wherein steps S1′ and S4′ are identical to steps S1 and D4 in FIG. 4, respectively, which would not be detailed here, but are incorporated here by reference.

Herein, in step S5′, the user equipment 2 obtains scene-related information corresponding to the real scene; in step S2′, the user equipment 2 may also send the access request to the network device 1, wherein the access request includes the scene-related information; the network device 1 obtains the access request; in step S3, the network device 1 performs match query in the shared object repository based on the scene image and the scene-related information, so as to obtain said one or more shared objects. Specifically, in step S5′, the user equipment 2 obtains scene-related information corresponding to the real scene, for example, description information, keyword information and the like of the real scene, through for example, a locating service of the real scene, or receiving a user's annotation of the scene, or performing image recognition onto the scene image, and the like manner; and then in step S2, the user equipment 2 generates an access request based on the scene image obtained in step S5′ and the scene-related information obtained in step S5′, and sends the access request to the network device 1; after the network device 1 obtains the access request, in step S3′, the network device 1 parses the scene image and the scene-related information from the access request, and performs match query in the shared object repository based on the tag or keyword of the scene image in conjunction with the content in the scene-related information, thereby obtaining said one or more shared objects. Here, the scene-related information may not only be obtained independently by the network device 1, but also may be the scene-related information recorded by the user equipment 2 or obtained by other product or a third-party device. For example, the scene-related information may be a geographical location of the scene “Shanghai Xuhui District Caoxi Beilu No. 333” obtained by the user equipment 2 through a global positioning service (GPS), or “Xujiahui Electronics Mall” obtained by receiving an annotation added by a user, or a scene shape “Bird's Nest” obtained through image recognition processing, and etc. Those skilled in the art should understand that the above manners of obtaining scene-related information is only exemplary, and other existing or future possibly emerging manners of obtaining scene-related information, if applicable to the present invention, should also be included within the protection scope of the present invention, which are incorporated here by reference.

Preferably, the scene-related information includes, but not limited to:
location information of the real scene;
descriptive information of the real scene;
symbolic information of the real scene;

Specifically, the scene-related information may help the network device 1 to more accurately determine, in step S3′, a real scene corresponding to an access request, which is based on a scene image corresponding to the real scene, thereby obtaining one or more shared objects corresponding to the access request. With the location information as an example, when the user equipment 2 obtains the scene-related information “No. 333, Caoxi Beilu, Xuhui District, Shanghai” through a global positioning service (GPS) in step S5′, the network device 1 can determine that the real scene is “Xujiahui Buynow Plaza,” based on the content, tag and keywords of the scene image in conjunction with the scene-related information, thereby obtaining one or more corresponding shared objects. With the descriptive information as an example, when the user equipment 2 obtains that the scene-related information is “Xujiahui Electronics Mall” through an annotation added by the user in step S5′, the network device 1 can also determine, in step S3′, that the real scene is “Xujiahui Buynow Plaza,” based on the content, tag and keywords of the scene image in conjunction with the scene-related information. With the symbolic information as an example, when the user equipment 2 obtains that the scene-related information is “Bird's Nest” through image recognition processing in step S5′, the network device 1 can determine, in step S3′, that the real scene is just the “National Stadium” based on the content, tag and keywords of the scene image in conjunction with the scene-related information. Those skilled in the art should understand that the above scene-related information is only exemplary, and other existing or future possibly emerging scene-related information, if applicable to the present invention, should also be included within the protection scope of the present invention, which are incorporated here by reference.

More preferably, the scene-related information includes location information of the real scene, wherein in step S5′, the user equipment 2 is further configured to obtain the location information corresponding to the real scene through a location providing service. Preferably, the location information includes, but not limited to: 1) absolute geographical location information, for example, the longitude and latitude of the real scene; 2) relative geographical location information of the scene, for example, “located at the intersection between Hongkou District and Zhabei District.” More preferably, in step S5′, the manner in which the user equipment 2 obtains the location information corresponding to the real scene includes, but not limited to: performing global positioning system (GPS) positioning, cellular base station positioning or location server positioning to the real scene. For example, in step S5′, the user equipment 2 obtains that the location information of a scene is “No. 333, Caoxi Beilu, Xuhui District, Shanghai” through GPS positioning, and then in step S2′, the user equipment 2 sends an access request including the location information to the network device 1; in step S3′, the network device 1 finds the shared object corresponding to “Xujiahui Buynow Plaza” through match queries based on the location information. Those skilled in the art should understand that the above manners of obtaining location information are only exemplary, and other existing or future possibly emerging manners of obtaining location information, if applicable to the present invention, should also be included within the protection scope of the present invention, which are incorporated here by reference.

In a preferred embodiment (see FIG. 4), in step S6 (not shown), the network device 1 may further perform image recognition processing onto the scene image so as to obtain image-related information corresponding to the scene image, wherein in step S3, the network device 1 performs match query in the shared object repository based on the scene image and the image-related information so as to obtain said one or more shared objects. Specifically, in step S2, after the network device 1 obtains from the user equipment 2an access request based on the scene image corresponding to the real scene, the network device 1 parses the scene image therefrom, and then in step S6, the network device 1 performs to the scene image recognition, including, but not limited to, characteristic recognition, word recognition, or edge recognition, thereby obtaining image-related information corresponding to the scene image, for example, background information, descriptive information of the image, and the like. Afterwards, in step S3, the network device 1 performs match query in the shared object repository based on the content of the image-related information to obtain said one or more shared objects. For example, in step S6, if the network device 1 identifies that the scene image sent by the user is “Buybow Plaza,” then in step S3, the network device 1 would immediately perform match query in the shared object repository based on the mapping relationships between shared objects and scene identifications, thereby obtaining one or more shared objects with mapping relationships with “Buynow Plaza.” Those skilled in the art should understand that the above manners of obtaining image-related information is only exemplary, and other existing or future possibly emerging manners of obtaining image-related information, if applicable to the present invention, should also be included within the protection scope of the present invention, which are incorporated here by reference.

More preferably, the image-related information includes at least one of the following:
background information corresponding to the scene image;
object information corresponding to the scene image;
keyword information corresponding to the scene image.
   Specifically, the image recognition process includes, but limited to, performing characteristic recognition, word recognition or edge recognition to the scene image. With edge recognition and background information as example, if a user sends a picture with “Shanghai Oriental Pearl” as the background, then the network device 1, in step S6, first positions the intersection line between the building and other background, and then judges that the edge contour line is a combination of three “spheres” with different dimensions but arranged orderly and several “cylinders,” thereby deriving background information that the building is “Shanghai Oriental Pearl.” With word recognition and object information as example, if a user sends a picture shot with “ [symbol] ” signboard as a shooting object, the network device 1, in step S6, first extracts the words in the picture, and immediately recognizes “ [symbol] ,” “ [symbol] ,” “ [symbol] ,” “ [symbol] ,” “ [symbol] ,” “ [symbol] ,” “ [symbol] ” through word recognition, thereby deriving object information that the scene is “ [symbol] .” With characteristic recognition and keyword information as an example, if the user sends a picture containing “Xujiahui Catholic Church,” since the catholic church has a more eye-catching character than other buildings, for example, spire, long lines, densely arranged, in step S6, the network device 1 may recognize, through these features, the characteristic information that the scene is “Xujiahui Catholic Church.” Afterwards, in step S3, the network device 1 can perform match query in the shared object repository based on the obtained image-related information, for example, “Shanghai Oriental Pearl,” “ [symbol] ,” or “Xujiahui Catholic Church.” Those skilled in the art should understand that the above image-related information is only exemplary, and other existing or future possibly emerging image-related information, if applicable to the present invention, should also be included within the protection scope of the present invention, which are incorporated here by reference.

More preferably (see FIG. 5), in step S3′, the network device 1 performs match query in the shared object repository based on the scene image and the scene-related information in conjunction with the image-related information, thereby obtaining said one or more shared objects. Specifically, in step S3′, the network device 1 performs match query in the shared object repository based on the scene image obtained in step S2′ and the scene-related information (e.g., location information, descriptive information, symbolic information) obtained in step S5′, in conjunction with the image-related information (e.g., background information, object information, keyword information) obtained by the network device 1 in step S6. For example, in step S2′, the network device 1, besides the scene image obtained by the user equipment 2 in step S1′, also obtains the scene-related information obtained by the user equipment 2 in step S5′, for example, the location information “No. 333, Caoxi Beilu, Xuhui District, Shanghai” obtained through GPS positioning, and meanwhile the network device 1 in step S6 derives, through the image recognition technology, that the background information of the scene image is “Xujiahui Buynow.” And then the network device 1, in step S3′, first matches the location information, and when the location information is successfully matched with the location information of the scene identification “Xujiahui Buynow Plaza,” further matches the image-related information, where a certain error-tolerant mechanism is allowed with respect to the matching degree of the image-related information. For example, the network device 1 may be set such that if the location information is completely identical, and 80% of the image-related information matches, then a shared object corresponding to the scene identification is obtained. Those skilled in the art should understand that the above manner of obtaining a shared object is only exemplary, and other existing or future possibly emerging manners of obtaining a shared object, if applicable to the present invention, should also be included within the protection scope of the present invention, which are incorporated here by reference.

In another preferred embodiment (see FIG. 4), in step S4, the network device 1 provides said one or more shared objects to the user equipment 2 based on object state information corresponding to said one or more shared objects. Specifically, in step S4, the network device 1 provides said one or more shared objects to the user equipment 2 based on said one or more shared objects obtained in step S3 in conjunction with the object state information corresponding to said one or more shared objects, for example, tag information, class information, layer information, attribute information, and layout information of the shared object. For example, the network device 1 may establish or update the shared object repository based on object sharing operations of a considerable number of users with respect to shared objects of one or more real scenes in conjunction with object state information of the shared object. Therefore, not only the shared object repository stores a considerable number of shared objects, but also different shared objects are of their own different object state information. Specifically, the network device 2 can store different objects into different categories or tags based on different contents and categories of shared objects; therefore, in step S4, the network device 1 may provide one or more shared objects to the user based on different categories or tags. Those skilled in the art should understand that the above manner of providing a shared object is only exemplary, and other existing or future possibly emerging manners of providing a shared object, if applicable to the present invention, should also be included within the protection scope of the present invention, which are incorporated here by reference.

Preferably, the object state information includes at least one of the following:
tag information of the shared object;
category information of the shared object;
layer information of the shared object;
attribute information of the shared object;
layout information of the shared object.
   Here, the tag information includes, but not limited to, scene identification mapped to a shared object. For example, the tag of “discount information a” is “Landmark Plaza,” the tag of “discount information b” is “Buynow Plaza,” and so forth. The category information includes, but not limited to, the kind of a shared object, for example, “article information,” “service information,” “traffic information.” The layer information includes, but not limited to display image layer of the shared object on a screen. For example, the background computer may set shared objects of different categories on different layers. Continue the above example. Suppose the scene image of “Buynow” as initially seen on the screen is the first layer, then the shared object of the “article information” category is overlapped and displayed on the first layer, i.e., the second layer; that of the “service information” category is displayed on the third layer, and so forth, which facilitates the user to choose shared objects of the appropriate category. The attribute information includes, but not limited to, type (for example, text, image, or a combination of text and image) of the shared object, the content, size, or shape of the shared object, and the like. The layout information includes, but not limited to, displaying location of a shared object on the screen. For example, the background computer may set shared objects of different categories on different locations of the screen. Continue the above example. Suppose it is the scene image of “Buynow Plaza” that is initially displayed on the screen, then the shared object of the “article information” category is displayed above the scene image, while that of the “service information” one is displayed below the scene image, and so forth, for the user to distinguish the shared objects. Preferably, the object state information of the shared object may not only be independently obtained by the network device 1, for example, automatically set in the ground according to image recognition, content recognition or location recognition; but also the object state information may be received from the records of the user equipment 2, for example, object state information set by the user per se; or the object state information may be received from the object state information of the shared object obtained by other product or a third party device. Those skilled in the art should understand that the above object state information is only exemplary, and other existing or future possibly emerging object state information, if applicable to the present invention, should also be included within the protection scope of the present invention, which are incorporated here by reference.

In a further preferred embodiment (see FIG. 4), in step S3, the network device 1 performs match query in the shared object repository based on the scene image in conjunction with user-related information of the user, thereby obtaining said one or more shared objects. Specifically, in step S3, the network device 1 parses the scene image corresponding to the real scene from the access request of the scene image obtained in step S1, and performs match query in the shared object repository based on the scene image in conjunction with the user-related information of the user, for example, basic attributes, geographical location, and historical operation log and the like of the user, so as to obtain one or more shared objects corresponding to the access request. For example, for men, women, children, the old, etc., when the scene image provided by them includes “** shopping mall,” their actual needs differ greatly, wherein men users may feel more interested in sports products, men clothes, and electronics; women users may feel more interested in skincare/cosmetics products, women clothes; children may feel more interested in children clothes, children readings, and cartoons; while old users may feel more interested in clothes for the old, healthcare products. Of course, a user's personal background (e.g., education background, life background, religion background) may also become factors affecting the obtaining of shared objects. For example, a user with overseas study or living background feels more interested in imported articles than a general user. Besides, a user's historical operation log may also become indication information for determining a shared object. Here, the user-related information may not only be obtained independently by the network device 1, but also may be the user-related information recorded by the user equipment 2 or the user-related information obtained by other product or a third-party device. Those skilled in the art should understand that the above manner of obtaining a shared object is only exemplary, and other existing or future possibly emerging manners of obtaining a shared object, if applicable to the present invention, should also be included within the protection scope of the present invention, which are incorporated here by reference.

More preferably, the user-related information includes at least one of the following:
basic attributes of the user;
geographical location of the user;
historical operation log of the user.
   Herein, the user's basic attributes include, but not limited to, personal background information pre-entered by the user (for example, gender, age, religion, nationality, education degree, etc.), and the user's preference information, etc.; the user's geographical location includes, but not limited to, the user's absolute geographical location (e.g., longitude, latitude), or the user's relative geographical location (e.g., the intersection between which district and which district); the user's historical operation log includes, but not limited to, the user's purchase history log, viewing log, etc. In step S3, the network device 1 performs match query in a shared object repository based on the scene image, in conjunction with the user-related information of the user, so as to obtain one or more shared objects corresponding to the access request. For example, when a user scans a scene image of a Carrefour supermarket, if the user's geographical location shows that he/she is located in the Wujiaochang region and the user is elderly and likes buying discount articles, then in step S3, the network device 1 can obtain the discount information of Wujiaochang Carrefour supermarket based on the above user information. When the user's geographical location shows that he/she is in Wanli region and the user is relatively young and has an experience of living abroad, then in step S3, the network device 1 may obtain the imported articles information of Wanli Carrefour supermarket based on the above user information. Those skilled in the art should understand that the above user-related information is only exemplary, and other existing or future possibly emerging user-related information, if applicable to the present invention, should also be included within the protection scope of the present invention, which are incorporated here by reference.

In one preferred embodiment (see FIG. 4), in step S7 (not shown), the network device 1 may also obtain an object modification operation performed by the user to at least one of said one or more shared objects; and builds or updates the shared object repository based on the object modification operation in conjunction with a scene identification corresponding to the object modification operation in the shared object repository. Specifically, in step S7, according to interaction with the user equipment 2 and the user, the network device 1 obtains an object modification operation to at least one thereof after the user receives one or more shared objects through the user equipment 2, for example, modifying the content, shape, and layer and the like of the shared object, and builds or updates the shared object repository, based on a scene identification corresponding to the object modification operation in the shared object repository. For example, when the user obtains a shared object in the shared object repository through shooting and uploading a scene image, the user may modify the shared object and opt to continue updating it to the shared object repository. Then the shared object as subsequently obtained by a user is just the modified shared object. Preferably, the modification rights of the shared object may be set by the user or by the background computer. More preferably, when setting the modification rights, the user or background computer may limit the body that could modify the shared object, for example, only the user per se can modify the shared object, or limit the shared object state information that may be modified, for example, only the layer information of the shared object may be modified. Those skilled in the art should understand that the above manner of building or updating a shared object repository is only exemplary, and other existing or future possibly evolving manners of building or updating a shared object repository, if applicable to the present invention, should also be included within the protection scope of the present invention, which are incorporated here by reference.

In another preferred embodiment (see FIG. 4), in step S8 (not shown), the network device 1 further obtains object sharing operations performed by a number of users to shared object of one or more real scenes; and build or update the shared object repository based on the object sharing operations in conjunction with scene identifications corresponding to the object sharing operations in the shared object repository. Specifically, in step S8, according to interaction with the user equipment 2 and the user, the network device 1 obtains object sharing operations of a considerable number of users, and records and updates the object repository based on the scene identification corresponding to the object sharing operations in the shared object repository, for example, the preset information and scene identification entered by the users. Therefore, the shared object repository not only stores a great amount of shared objects and scene identifications (the forms of storing include, but not limited to, words, document, picture, etc.) and meanwhile sores mapping relationships between the shared objects and the scene identifications. Preferably, the forms of storing the mapping relationships include, but not limited to: a) storing as independent data; b) storing the shared objects and scene identifications into a corresponding table; c) storing the scene identifications as state information of the shared objects (for example, the tags of the shared objects). For example, if a user wants to reserve a virtual note at some place in advance, he may edit the content of the note and a corresponding address in advance and store it in the shared object repository. Those skilled in the art should understand that the above manner of building or updating a shared object repository is only exemplary, and other existing or future possibly evolving manners of building or updating a shared object repository, if applicable to the present invention, should also be included within the protection scope of the present invention, which are incorporated here by reference.

To those skilled in the art, it is apparent that the present invention is not limited to the details of the above exemplary embodiments, and the present invention may be implemented with other embodiments without departing from the spirit or basic features of the present invention. Thus, in any way, the embodiments should be regarded as exemplary, not limitative; the scope of the present invention is limited by the appended claims, instead of the above depiction. Thus, all variations intended to fall into the meaning and scope of equivalent elements of the claims should be covered within the present invention. No reference signs in the claims should be regarded as limiting the involved claims. Besides, it is apparent that the term “comprise” does not exclude other units or steps, and singularity does not exclude plurality. A plurality of units or modules stated in a system claim may also be implemented by a single unit or module through software or hardware. Terms such as the first and the second are used to indicate names, but do not indicate any particular sequence.

1. A method for obtaining a shared object associated with a real scene at a network device, wherein the method comprises the following steps:
a. obtaining an access request sent by a user through user equipment and based on a scene image corresponding to a real scene;
b. performing match query in a shared object repository based on the scene image so as to obtain one or more shared objects corresponding to the access request; and
c. providing said one or more shared objects to the user equipment.

2. The method according to claim 1, wherein obtaining an access request sent by a user through user equipment and based on a scene image corresponding to a real scene comprises:
obtaining the access request, wherein the access request includes scene-related information corresponding to the real scene;
wherein, performing match query in a shared object repository based on the scene image so as to obtain one or more shared objects corresponding to the access request comprises:
performing match query in the shared object repository based on the scene image and the scene-related information, so as to obtain said one or more shared objects.

3. The method according to claim 2, wherein the scene-related information comprises at least one of the following items:
location information of the real scene;
descriptive information of the real scene; or
symbolic information of the real scene.

4. The method according to claim 1, wherein the method further comprises:
performing image recognition processing on the scene image so as to obtain image-related information corresponding to the scene image;
wherein, performing match query in a shared object repository based on the scene image so as to obtain one or more shared objects corresponding to the access request comprises:
performing match query in the shared object repository based on the scene image and the image-related information, so as to obtain said one or more shared objects.

5. The method according to claim 4, wherein the image-related information comprises at least one of the following items:
background information corresponding to the scene image;
object information corresponding to the scene image; or
keyword information corresponding to the scene image.

6. The method according to claim 1, wherein providing said one or more shared objects to the user equipment comprises:
providing said one or more shared objects to the user equipment based on object state information corresponding to said one or more shared objects.

7. The method according to claim 6, wherein the object state information comprises at least one of the following items:
tag information of the shared object;
category information of the shared object;
layer information of the shared object;
attribute information of the shared object; or
layout information of the shared object.

8. The method according to claim 1, wherein performing match query in a shared object repository based on the scene image so as to obtain one or more shared objects corresponding to the access request comprises:
performing match query in the shared object repository based on the scene image in conjunction with user-related information of the user, so as to said one or more shared objects.

9. The method according to claim 8, wherein the user-related information comprises at least one of the following items:
basic attributes of the user;
geographical location of the user; or
historical operation log of the user.

10. The method according to claim 1, wherein the method further comprises:
obtaining an object modification operation performed by the user to at least one of said one or more shared objects; and
building or updating the shared object repository based on the object modification operation in conjunction with a scene identification corresponding to the object modification operation in the shared object repository.

11. The method according to claim 1, wherein the method further comprises:
obtaining object sharing operations performed by a number of users to shared objects of one or more real scenes; and
building or updating the shared object repository based on the object sharing operations in conjunction with scene identifications corresponding to the object sharing operations in the shared object repository.

12. A method for facilitating obtaining a shared object associated with a real scene at user equipment, wherein the method comprises the following steps:
obtaining a scene image corresponding to a real scene, the scene image being provided by a user through user equipment;
sending an access request based on the scene image to a network device; and
receiving one or more shared objects based on the access request, said one or more shared objects being sent from the network device.

13. The method according to claim 12, wherein the method further comprises:
obtaining scene-related information corresponding to the real scene; and
wherein, sending an access request based on the scene image to a network device comprises:
sending the access request to the network device, wherein the access request comprises the scene-related information.

14. The method according to claim 13, wherein the scene-related information comprises location information of the real scene; and
wherein, obtaining scene-related information corresponding to the real scene further comprises:
obtaining the location information corresponding to the real scene through a location providing service.

15. A network device for obtaining a shared object associated with a real scene, wherein the network device comprises:
first obtaining module configured to obtain an access request sent by a user through user equipment and based on a scene image corresponding to a real scene;
query module configured to perform match query in a shared object repository based on the scene image so as to obtain one or more shared objects corresponding to the access request; and
providing module configured to provide said one or more shared objects to the user equipment.

16. The network device according to claim 15, wherein the first obtaining module is configured to obtain the access request, wherein the access request includes scene-related information corresponding to the real scene; and
wherein the querying module is configured to perform match query in the shared object repository based on the scene image and the scene-related information, so as to obtain said one or more shared objects.

17. The network device according to claim 16, wherein the scene-related information comprises at least one of the following items:
location information of the real scene;
descriptive information of the real scene; or
symbolic information of the real scene.

18. The network device according to claim 15, wherein the network device further comprises an identifying module configured to perform image recognition processing on the scene image so as to obtain image-related information corresponding to the scene image; and
wherein the querying module is configured to perform match query in the shared object repository based on the scene image and the image-related information, so as to obtain said one or more shared objects.

19. The network device according to claim 18, wherein the image-related information comprises at least one of the following items:
background information corresponding to the scene image;
object information corresponding to the scene image; or
keyword information corresponding to the scene image.

20. The network device according to claim 15, wherein the providing module is configured to provide said one or more shared objects to the user equipment based on object state information corresponding to said one or more shared objects.

21. The network device according to claim 20, wherein the object state information comprises at least one of the following items:
tag information of the shared object;
category information of the shared object;
layer information of the shared object;
attribute information of the shared object; or
layout information of the shared object.

22. The network device according to claim 15, wherein the query module is configured to perform match query in the shared object repository based on the scene image in conjunction with user-related information of the user, so as to obtain said one or more shared objects.

23. The network device according to claim 22, wherein the user-related information comprises at least one of the following items:
basic attributes of the user;
geographical location of the user; or
historical operation log of the user.

24. The network device according to claim 15, wherein the network device further comprises a first updating module configured to:
obtain an object modification operation performed by the user to at least one of said one or more shared objects; and
build or update the shared object repository based on the object modification operation in conjunction with a scene identification corresponding to the object modification operation in the shared object repository.

25. The network device according to claim 15, wherein the network device further comprises a second updating module configured to:
obtain object sharing operations performed by a number of users to shared objects of one or more real scenes; and
build or update the shared object repository based on the object sharing operations in conjunction with scene identifications corresponding to the object sharing operations in the shared object repository.

26. A user equipment for facilitating obtaining a shared object associated with a real scene, wherein the user equipment comprises:
an obtaining module configured to obtain a scene image corresponding to a real scene, the scene image being provided by a user;
a sending module configured to send an access request based on the scene image to a network device; and
a receiving module configured to receive one or more shared objects based on the access request, said one ore more shared objects being sent from the network device.

27. The user equipment according to claim 26, wherein the user equipment further comprises a third obtaining module configured to obtain scene-related information corresponding to the real scene; and
wherein the sending module is configured to send the access request to the network device, wherein the access request comprises the scene-related information.

28. The user equipment according to claim 27, wherein the scene-related information comprises location information of the real scene; and
wherein the third obtaining module is further configured to obtain the location information corresponding to the real scene through a location providing service.

29. A system for obtaining a shared object associated with a real scene, comprising the network device according to claim 15, and a user equipment comprising:
an obtaining module configured to obtain a scene image corresponding to a real scene, the scene image being provided by a user;
a sending module configured to send an access request based on the scene image to a network device; and
a receiving module configured to receive one or more shared objects based on the access request, said one or more shared objects being sent from the network device.
